(19) United States
(12) Patent Application Publication
(10) Pub. No.: US 2025/0334201 A1
(43) Pub. Date: Oct. 30, 2025

(54) VALVE DEVICE, MOLDING MACHINE AND METHOD FOR CONTROLLING A VALVE DEVICE

(71) Applicant: Heinrich Wagner Sinto Maschinenfabrik GmbH, Bad Laasphe (DE)

(72) Inventor: Matthias Dittrich, Biedenkopf (DE)

(21) Appl. No.: 19/188,191

(22) Filed: Apr. 24, 2025

(30) Foreign Application Priority Data
Apr. 25, 2024 (EP) 24172451.7

(51) Int. Cl. F16K 31/122; B22C 15/08; F16K 15/06; F16K 15/18; F16K 31/06; F16K 37/00

(52) U.S. Cl. CPC F16K 31/1221; B22C 15/08; F16K 15/063; F16K 15/182; F16K 31/0603; F16K 37/0041

(57) ABSTRACT

A valve device (10) having a check valve mechanism (20) having a valve rod (21) and a closing element (22) disposed on one end of the valve rod (21) and intended for the compressed-air supply to a consumer (11), the valve device (10) further having an actuation mechanism (30) having a hydraulic cylinder (31), the piston (32) of the hydraulic cylinder (31) being firmly connected to the valve rod (21) and being hydraulically driven within the cylinder casing (33) of the hydraulic cylinder (31) in order to actuate the check valve mechanism (20). A control mechanism (40) for controlling the piston movement and a measuring mechanism (50) for detecting the piston position is comprised, a proportional-valve mechanism (60), which is controllable by the control mechanism (40) as a function of the piston position, being connected to the hydraulic cylinder (31) in a fluid-conducting manner. A molding machine and method for controlling a valve device are also disclosed.

This application claims priority to European patent application no. 24172451.7 filed on Apr. 25, 2024, the disclosure of which is hereby incorporated by reference.

### TECHNICAL FIELD

The invention relates to a valve device having a check valve mechanism having a valve rod and a closing element disposed on one end of the valve rod and intended for the compressed-air supply to a consumer, the valve device further having an actuation mechanism having a hydraulic cylinder, the piston of the hydraulic cylinder being firmly connected to the valve rod and being hydraulically driven within the cylinder casing of the hydraulic cylinder in order to actuate the check valve mechanism. The invention also relates to a molding machine and a method for controlling a valve device.

### DESCRIPTION

When compacting molding material, for example molding sand, in a molding machine to produce a mold from the molding material and other comparable applications, it is usually necessary to supply compressed air to the consumer, for example a molding box of a molding machine. However, the compressed air for pneumatic compression of the molding material should not be applied to the molding material abruptly because, for example, in the case of compressing molding sand, the molding sand cannot be compressed uniformly throughout. On the other hand, a corresponding mechanism works inefficiently if too much time passes before the required pressure of the compressed air supplied to the consumer is reached. Pneumatic check valves, which can be closed or opened using an actuation mechanism, are regularly provided for the targeted application of compressed air. The closing element of the check valves can close or open a cylinder casing which can be filled with compressed air, with the compressed air flowing in the direction of the consumer when the check valve is opened. The check valve can be actuated by means of the actuation mechanism, which is operated hydraulically, for example. Such generic actuation mechanisms regularly have a discretely switching way valve, for example a 4/2-way valve, for actuating a hydraulically movable cylinder which is connected to the check valve. In other words, this means that, generically, an air flow can be directed to the consumer by means of a discretely controlled hydraulic cylinder. Both the piston stroke and the discrete opening times of the check valve are generically set and readjusted manually, which can lead to excessive consumption of compressed air, which is relatively cost-intensive to generate. In addition, the discrete switching behavior of the way valve controlling the hydraulic cylinder does not offer the possibility of actively regulating and controlling the air flow, for example to optimize compressing the molding material. This significantly reduces the precision and accuracy of the compressed-air supply to the consumer and also leads to increased energy loss.

### SUMMARY

The object of the invention is therefore to design a valve device and a method for controlling a valve device in such a manner that the supply of a compressed air flow to a consumer can be actively regulated and controlled and an increased energy efficiency can be ensured. In addition, the device and/or method according to the invention should be easy to implement, manufacture and service. Furthermore, the valve device and/or the method should be able to be implemented without significantly increasing the current required cycle times of an installation, which are standardly required, in which the valve device or the method is used.

To attain this object, a device is proposed. Furthermore, a molding machine having such a valve device is proposed. A method for controlling a check valve mechanism is also proposed.

The valve device according to the invention has a check valve mechanism having a valve rod and a closing element disposed on one end of the valve rod and intended for the compressed-air supply to a consumer, for example to a molding box containing the molding material to be compressed. In addition, the valve device has an actuation mechanism having a hydraulic cylinder, the piston of the hydraulic cylinder being firmly connected to the valve rod and being hydraulically driven within the cylinder casing of the hydraulic cylinder in order to actuate the check valve mechanism. In other words, the piston can be moved within the cylinder casing by being subjected to hydraulic pressurization. Due to the fact that the valve rod is firmly connected to the piston of the hydraulic cylinder, the valve rod with the closing element attached thereto is also moved when the piston is moved and can release or block a compressed-air supply to a consumer. The closing element can be designed as a valve cone or valve disk, for example. The closing element can interact with a valve seat in such a manner that the closing element rests on the valve seat when the compressed-air supply to a consumer is blocked and seals the consumer from the compressed-air supply. The closing element can be loaded by a compressed-air flow in the closing direction of the check valve mechanism. The valve rod is preferably provided on the closing element on the side opposite the valve seat. The longitudinal axis of the valve rod preferably extends parallel to the movement direction of the piston.

The valve device according to the invention is characterized in that the valve device has a control mechanism for controlling the piston movement and a measuring mechanism for detecting the piston position. The piston movement can preferably be a piston stroke movement. By connecting the piston to the closing element of the check valve mechanism, the position of the check valve mechanism and thus the compressed-air supply to the consumer can also be regulated by controlling the piston movement. In the context of the invention, it has been recognized that a measuring mechanism which determines the piston position is advantageous for controlling the piston movement. The piston position can also be used to determine the piston stroke, which can also be referred to as the stroke length, and/or the position of the closing element of the check valve mechanism.

Furthermore, it has been recognized as essential in the context of the invention that a proportional-valve mechanism, which is controllable by the control mechanism as a function of the piston position, is connected to the hydraulic cylinder in a fluid-conducting manner. The proportional valve mechanism is connected to the hydraulic cylinder in such a fluid-conducting manner that the supply and discharge of a compressed fluid which is provided in a corresponding compressed-fluid source and can also be referred to as hydraulic fluid can be fed into the hydraulic cylinder and be discharged from the hydraulic cylinder. For this purpose, hydraulic pipes can be disposed between the hydraulic cylinder and the compressed-fluid source, the proportional valve mechanism being disposed between the hydraulic cylinder and the compressed-fluid source.

In the context of the invention, a proportional valve mechanism is a continuous valve device which, preferably by means of a proportional magnet, not only permits discrete switching positions, but also enables a continuous transition of the valve opening. This allows variable volume flows, in this case a compressed fluid, to be fed to the hydraulic cylinder. A proportional valve mechanism can be electromagnetically controlled and can assume any intermediate position between fully open and fully closed. In order to adjust the dischargeable volume flow, the proportional valve mechanism can have at least one, preferably several, axially displaceable valve pistons as shut-off bodies, which connect or close the corresponding inlet and outlet connections. The proportional valve direction of the valve device according to the invention thus allows precise control of the volume flow of compressed fluid supplied to the hydraulic cylinder due to the continuous switching behavior of the proportional valve mechanism. The proportional valve mechanism can be operated in a current-controlled and/or voltage-controlled manner.

In the context of the invention, it has been recognized that both the speed and the acceleration of the piston during the piston movement can be determined on the basis of the determination of the piston position, taking into account the time. Thus, the control mechanism can control the proportional valve mechanism depending as a function of the piston position, the piston speed and/or the piston acceleration.

The control mechanism in conjunction with the active monitoring of the piston position and/or the piston movement by the measuring mechanism means that changes in the movement, in particular the travel, of the piston can be detected at an early stage and an appropriate readjustment can be made. In addition, the measuring mechanism and/or control mechanism can detect maintenance requirements at an early stage and carry them out as remote maintenance, for example via remote connections, which improves the ability to plan maintenance work and also reduces costs. Furthermore, the valve device according to the invention enables simple commissioning of the valve device and the consumer connected to the valve device, since the piston movement, in particular the adjustment of the piston stroke, no longer has to be carried out manually by the fitter, for example via a throttle, but can be carried out automatically using the control mechanism. Later adjustments of the valve device, for example when changing a consumer, can also be made without manual adjustment of the check valve mechanism or the actuation mechanism itself, as these can be made via the control mechanism, for example by entering a desired target value via an interface to the control mechanism. Furthermore, the output of compressed air to a consumer can also be adapted much more variably and flexibly to the consumer, which can improve the application of compressed air to the consumer, for example for compressing molding sand. Advantageously, the opening times of the check valve mechanism can also be controlled more precisely and energy efficiency can be increased. The assembly of the valve device according to the invention does not require any additional effort compared to a generic valve device, as it can be easily attached to a consumer or retrofitted to existing consumers.

The valve device according to the invention can preferably be disposed on a molding machine, in particular a machine for producing casting molds, or a core shooter.

Advantageous embodiments of the invention are the subject of the dependent claims. In addition, all combinations of at least two features disclosed in the description, the claims and/or the figures fall within the scope of the invention. It is understood that the explanations made with respect to the valve device refer in an equivalent manner to the molding machine according to the invention, without being mentioned separately for the latter. Likewise, all features and embodiments disclosed with respect to the valve device and/or the molding machine relate in an equivalent, albeit not identical, manner to the method according to the invention. In particular, it is understood that the present disclosure includes customary linguistic synonyms and/or a meaningful replacement of the respective terms within the framework of customary linguistic practice, in particular by using synonyms supported by the generally recognized language literature, without being explicitly mentioned in their respective formulation.

The measuring mechanism can have a laser triangulation sensor and/or a touchless path sensor and/or an ultrasonic distance sensor in order to detect the piston position. The displacement measuring sensor can preferably be designed as a magnetostrictive path sensor. In other words, the measuring mechanism can determine the piston position by means of laser triangulation and/or magnetostrictive path measurement and/or ultrasonic distance measurement. Furthermore, the measuring mechanism can be configured to detect not only the piston position but also a change in the piston position over a certain period of time so that the measuring mechanism can determine the speed and/or acceleration of the piston. The path measurement is advantageously contactless.

A laser triangulation sensor has at least one radiation source and one detector with an optical system. If light from the radiation source, preferably a laser, is applied to the measurement object, in this case the piston, it is reflected at a specific triangulation angle. The reflected light is then registered on the detector via the optics. This allows the distance to the piston and thus the position of the piston to be determined via the position and the light spot area. A magnetostrictive path sensor for determining a position can have a magnetostrictive measuring element, which is designed as a measuring rod, for example, a position magnet and evaluation electronics. The position magnet can be designed as a permanent magnet and be disposed inside or on the piston. To determine the piston position, a current pulse can be applied to the measuring element, which creates a magnetic field around the measuring element. The magnetic field lines of the measuring element can then cross with the magnetic field of the position magnet, which can be disposed on the piston. This crossing of the magnetic field lines can deform the magnetostrictive measuring element. This mechanical deformation can be related to the time elapsed since the initiation of the current pulse and thus the current position of the position magnet and therefore also of the piston can be determined. A resolution of up to 1 μm and a measuring frequency of up to 10000 Hertz can be achieved using the magnetostrictive displacement sensor. Additionally or alternatively, the position of the piston can be determined using at least one ultrasonic sensor based on the transit time of reflected ultrasonic pulses. The ultrasonic sensor can comprise an output stage, an ultrasonic transducer and an evaluation unit. The output stage is used to excite the ultrasonic transducer via a sinusoidal voltage and thus to emit an ultrasonic pulse. This ultrasonic pulse can be reflected on the piston. The position of the piston can be determined by evaluating the time between signal output and reception of the reflected signal as well as via the sound propagation speed. A resolution of up to 0.3 mm and a measuring frequency between 250 Hertz and 500 Hertz is preferably achieved. Determining the position using an ultrasonic sensor is advantageously inexpensive and easy to implement

The proportional valve mechanism can be designed as a 4/4 proportional valve and/or can comprise at least one 4/4 proportional valve. In the context of the invention, it has been recognized that the discretely switching way valves, usually designed as 4/2 way valves, are unsuitable for controlling the piston movement and thus for controlling the entire valve device. For this reason, a 4/4 proportional way valve is preferred, whose valve piston positions can be changed by electrically controlling an electromagnet, allowing the volume flow to be precisely controlled. The 4/4 proportional valve can have a rod and a magnet, which is disposed at each end of the rod and is also known as an armature, and a valve piston, which can to control the volume flows going in and/or out via the connections, as well as a coil, via which the magnets are subjected to a horizontal force. When a current is being applied to the coil, a magnetic field arises which exerts a force on the rod and/or the valve piston. The 4/4 proportional valve can have four connections, preferably the connections for tank (T), pressure (P) and the consumer connections A and B, whose volume flows can be regulated via the various valve piston positions. The connections for pressure and tank are connected to the compressed-fluid source, compressed fluid being able to be supplied to the proportional valve via the connection for pressure and compressed fluid can be discharged from the proportional valve via the connection for tank. One of the consumer connections A and B can be configured to supply the compressed fluid to the hydraulic cylinder and the other consumer connection can be configured to discharge the compressed fluid from the hydraulic cylinder. Furthermore, the valve piston position can be transferred to four main positions. When no current is being applied to the coil, the magnet or magnets are transferred to their home position via a return spring and the consumer connections A and B are closed. In the event of a defect and/or provided no signal is being applied, the valve pistons can be transferred to a so-called “fail-safe” position, in which the return spring is released to the maximum. In the right end position, the connection for tank and the consumer connection A as well as the connection for pressure and the consumer connection B are connected to each other, while in the left end position, the connection for tank and the consumer connection B as well as the connection for pressure and the consumer connection A are connected to each other.

The valve pistons of the proportional valve mechanism is displaceable by being current-controlled. In particular, the valve piston can be displaced by applying a current of 4 milliamperes to 20 milliamperes (mA) to the coil of the proportional valve mechanism. A value of 12 milliamperes can be set as a threshold value to determine the movement direction of the valve piston.

The control mechanism can have a PID controller (Proportional Integral Derivative Controller). The PID controller can take into account the piston position and/or the piston movement, so that the piston position and/or the piston movement can be an input signal of the PID controller. The output signal of the PID controller can be a control signal by means of which the proportional valve mechanism is controlled and via which the volume flow of compressed fluid in the hydraulic cylinder can be changed. For example, the output signal of the PID controller can be a correction current which can be used to change the position of the valve piston of the proportional valve mechanism. The control mechanism can be designed as a digital control mechanism. The control mechanism can have an analog-to-digital converter to record the control variables and a digital-to-analog converter to output the control variable.

The piston of the hydraulic cylinder can be double-acting. This double-acting piston can advantageously be moved and/or driven in two directions, whereby the need for a reset mechanism is eliminated. To drive the double-acting piston, compressed fluid can be supplied to the hydraulic cylinder at at least two openings to enable the piston to be lowered and raised.

A piston rod can be disposed on the piston of the hydraulic cylinder, opposite the valve rod and disposed so as to align flush with the axis thereof. The valve rod and the piston rod can have differing diameters. Due to the different diameters of the piston rod and the valve rod, the piston has two unequal piston surfaces. This can result in a different volume in the two cylinder chambers and allows an advantageous adjustment of the pressure ratios for moving the piston within the hydraulic cylinder. The piston rod can have a diameter between 50 mm and 60 mm, preferably 56 mm, and the valve rod can have a diameter between 40 mm and 50 mm, preferably 45 mm.

The movement of the piston can be limited by an immovable stop element. Preferably, the stop element can be adjustable. In this manner, a maximum compressed-air flow can advantageously be defined by the check valve mechanism, as the stroke of the closing element is limited by an immovable stop. If the stop is adjustable, the maximum opening of the check valve mechanism can be easily adjusted to different requirements.

A piston rod can be disposed on the piston of the hydraulic cylinder, opposite the valve rod and disposed so as to align flush with the axis of the valve rod. The free front face of the piston rod facing away from the closing element can be abutted against the stop element. In other words, the piston rod can contact the stop element with its front face facing away from the closing element and thus limit the stroke movement of the piston. To limit the piston stroke by means of a stop element, it is irrelevant whether the piston rod and the valve rod have a differing diameter or the same diameter. The valve rod and the piston rod can be designed in one piece. It is also conceivable that the piston of the hydraulic cylinder, the valve rod and the piston rod are designed in one piece.

When limiting the piston stroke, it can be advantageous for a stop damper to be provided on the free front face of the piston rod and/or on the stop element.

The valve device can have a stationary return spring which is disposed in such a manner that the valve rod is moved against the spring force of the return spring when opening the check valve mechanism. The return spring can be disposed in such a manner that the return spring is supported in a stationary manner on the stop element on the one hand and in an axially movable manner on a support element located on the piston rod on the other hand. A support collar of the support element can be fitted in such a manner that the return spring is largely guided on the piston rod. The return spring can be designed as a coil spring. The restoring force of the return spring can have a linear spring characteristic curve with a constant spring rate and act in the closing direction of the check valve mechanism. Furthermore, the restoring force of the return spring can be configured in such a manner that the restoring force does not change the valve characteristic curve of the valve blocking device.

An adjustable pressure control mechanism can be disposed upstream of the proportional valve element. The pressure control mechanism can be disposed between the proportional valve mechanism and the compressed-fluid source. The pressure control mechanism can be designed as a pressure reducing device. By controlling the pressure, a predetermined pressure of the compressed-fluid flow can be adjusted mechanically and/or electronically in a simple manner.

In a second aspect, the invention relates to a molding machine for compressing a molding material, the molding machine having a molding box fillable with the molding material, a model being disposed in the molding box, and the molding box being connected to a compressed-air supply. In this context, the molding machine has a valve device for releasing the compressed-air supply to the molding box, a mold being formed by being subjected to pressure and subsequently compressing the molding material. The molding machine can, for example, be designed for the production of casting molds or for the production of cores. The molding material can be molding sand, clay-bonded and/or bentonite-bonded green sand. By applying compressed air, the molding material is compressed on the model using the air flow. For final compaction of the molding material, the molding material can be further compressed, for example using a hydraulically driven stamping press, a different number of stamps being able to be used depending on the contour and size of the mold. The air introduced during the application to compressed air can escape from the molding box via at least one nozzle and/or at least one vent valve.

In a third aspect, the invention relates to a method for controlling a valve device having a check valve mechanism having a valve rod and a closing element disposed on one end on the valve rod and intended for the compressed-air supply to a consumer, the valve device further having an actuation mechanism having a hydraulic cylinder, the piston of the hydraulic cylinder being firmly connected to the valve rod and being able to be hydraulically driven within the cylinder casing of the hydraulic cylinder in order to actuate the check valve mechanism. According to the invention, the piston position being determined by means of a measuring mechanism, and the piston movement being controlled as a function of the determined piston position by a proportional-valve mechanism connected to the hydraulic cylinder in a fluid-conducting manner being controlled in such a manner that the volume flow of hydraulic fluid supplied to the hydraulic cylinder is changed. The method according to the invention can prevent a sudden opening of the compressed-air supply to the consumer and achieve a modulating opening behavior. In particular, the volumetric flow of compressed fluid, which is discharged via an outlet of the proportional valve mechanism, can be continuously changed and thus adjusted. In particular, the volume flow of compressed fluid supplied to the hydraulic cylinder can be controlled as a function of the determined piston position by adjusting the valve piston of the proportional valve mechanism in a current-controlled manner. Preferably, the method according to the invention can be used to control a valve device according to the invention according to a first aspect of the invention.

According to one embodiment of the method, the piston position and/or the piston stroke can be determined in regular temporal intervals by means of the measuring mechanism and be transmitted as an actual value to a control device. The actual value can be compared to a target value by means of the control mechanism, and the control signal emitted for controlling the proportional-valve mechanism being able to be changed by the control mechanism when a target value and an actual value deviate. Since the measuring mechanism is designed to determine the piston position, the measuring mechanism can also determine the piston stroke, since the piston stroke in the context of the invention is defined as the distance covered by the piston due to the application of compressed fluid in the hydraulic cylinder. The maximum piston stroke is the farthest distance which the closing element is from the valve seat at maximum opening of the compressed-air supply. Since the piston position in the lower end position, in which the compressed-air supply to the consumer is closed, is known, the maximum piston stroke, i.e., the distance between the lower and upper end position, can be easily determined by detecting the piston position in the upper end position. Depending on the requirements, for example depending on a molding material of the model and/or the molding box, a target value can be stored in the control mechanism for subjecting the consumer to pressure. This target value can be compared to the actual value at regular intervals, for example whenever an actual value is recorded. It is understood that the actual value and target value can have the same dimension, for example the piston stroke in millimeters. If there is a deviation between the target value and the actual value, the control signal which is emitted to control the proportional valve mechanism and can in particular be in the form of a control current, can be adjusted by the control mechanism, preferably automatically. This makes it easy to control the compressed-air supply without the need for manual intervention and/or empirical values.

Further advantageous embodiments of the method are derived from the feature descriptions of the dependent claims and the device claim referring to a molding machine.

### BRIEF DESCRIPTION OF THE DRAWINGS

Preferred embodiments are explained in more detail below with reference to the accompanying drawings.

FIG. 1 shows a sectional view of an embodiment of a molding machine according to the invention molding machine.

FIG. 2 shows a sectional view of an embodiment of a valve device according to the valve device.

FIG. 3 shows an embodiment of a 4/4 proportional valve of a valve device according to the invention.

### DETAILED DESCRIPTION

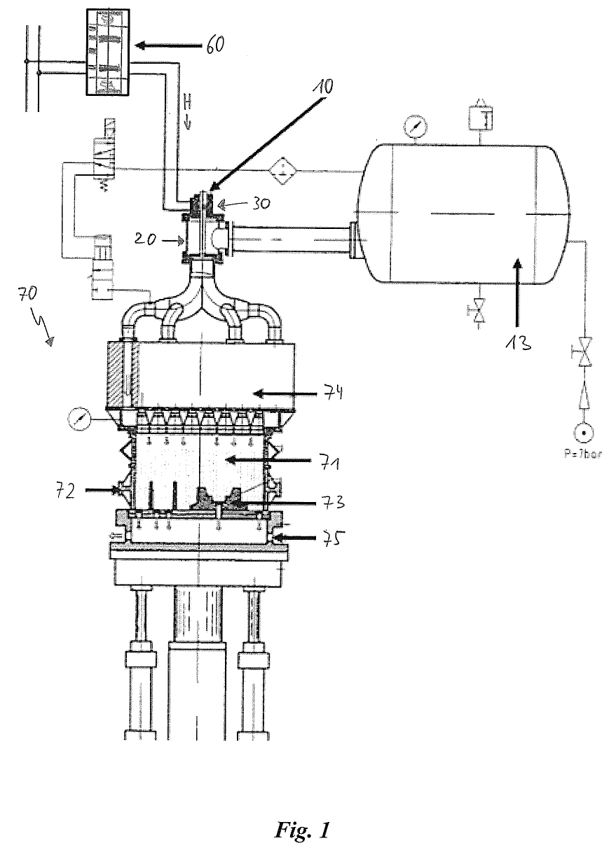

FIG. 1 shows a molding machine 70 according to the invention having a valve device 10 according to the invention. The molding material 71 can be filled into the molding box 72 via a metering device (not shown here) and can cover the model 73. By applying compressed air via the valve device 10 and then compressing the molding material 71 by means of the compressing mechanism 74, a mold can be produced, for example to produce a casting corresponding to the model 73. The compressed-air source 13 provides the compressed air required for applying compressed air and is connected to the valve device 10 in a compressed-air-conducting manner. In order to supply the molding box 72 with compressed air, the valve device has an actuation mechanism 30 to which compressed fluid H can be supplied. The volume flow of compressed fluid H, which is supplied to the actuation mechanism 30, can be controlled and changed by means of the proportional valve mechanism 60. By opening the check valve mechanism 20 by means of the actuation device 30, the compressed-air flow can be supplied to the molding box 72 and directed to the model 73. The compressed air source 13, for example a compressed-air tank, is mounted directly on the valve device 10 in order to provide a sufficient compressed-air supply and minimize pneumatic pressure drops. FIG. 1 shows that when the check valve mechanism 20 is opened, the compressed air flows via the compressing mechanism 74 into the molding box 72, which is preferably hermetically sealed. The air can then escape from the molding box 72 via air outlets 75, which can be designed as nozzles or vent valves, for example. After the molding material has been distributed and pre-compressed by the application of the compressed air, the molding material 71 can be compressed via the, preferably hydraulically operated, compressing mechanism 74 and be compressed as required to obtain a shape.

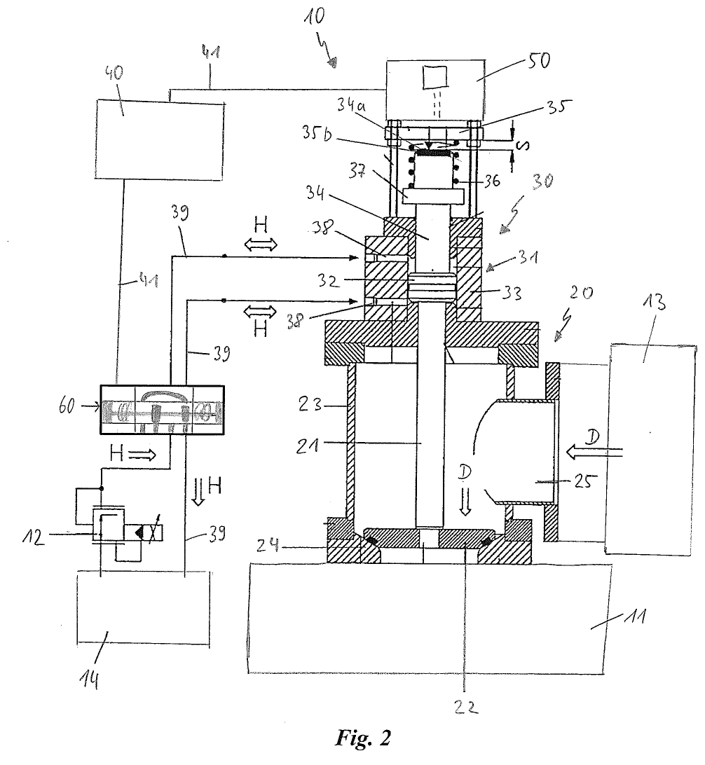

FIG. 2 shows the valve device 10 having a consumer 11 disposed on it, which can be designed as a molding box 71, for example. The check valve mechanism 20 for a compressed-air flow D from a compressed-air source 13 connected, for example, to an inlet flange of the multi-part check-valve casing 23 of the check valve mechanism 20 is equipped with a valve seat 22 which interacts with the closing element 22 designed as a valve disk in order to block a compressed-air supply to the consumer 11. The closing element 22, which can abut against the valve seat 24, is connected to one end of a valve rod 21, which is mounted in a passage for longitudinal movement, the passage being aligned with the valve seat 24 and leading to the cylinder casing 33 of the hydraulic cylinder 31. The closing element can thus be moved inside the check-valve casing 23 relative to the valve seat 24, whereby a compressed-air flow D can be supplied to the consumer 11. The compressed-air flow D passes from the compressed-air source 13 into the check-valve casing 23 via the connective fitting 25, which is disposed on the check-valve casing 23. A stationary stop element 35 is firmly connected to the cover of the cylinder casing 33, the distance between the stop element 35 and the cylinder casing 33 being able to be variably adjusted. A front face 34a of the piston rod 34 can strike against the stop element 35 via the stop damper 35b. FIG. 2 shows the check valve mechanism 20 in the closed state, so that the free stroke of the piston 32 determined by the stop element 35 and thus of the closing element 22 is recognizable. A return spring 36 can come into contact with the stop element 35, the return spring 36 being able to be designed as a coil spring surrounding the piston rod 34. The return spring 36 can be supported on the support collar 37 with its end farthest away from the stop element 35 so that the return spring 36 is disposed between the stop element 35 and the support collar 37. The cylinder casing 33 has two passages 38 in order to be able to feed the compressed fluid H, which can also be referred to as hydraulic fluid, to the cylinder casing 33 from the hydraulic pipes 39. The hydraulic pipes 39 connect the passages 38 to the proportional valve mechanism 60 and the proportional valve mechanism 60 to the compressed-fluid source 14, for example a hydraulic pump. The proportional valve mechanism 60 can continuously change the volume flow of the compressed fluid H to the hydraulic cylinder 31 of the actuation mechanism 30. Before the compressed fluid H is fed from the compressed-fluid source 14 to the proportional valve mechanism 60, the compressed fluid H can pass through a pressure control device 12, which is designed as a pressure reducer, for example, meaning the pressure of the compressed fluid H provided by the compressed-fluid source 14 can be reduced and/or adjusted. A measuring mechanism 50 is also disposed on the actuation device 30, the measuring mechanism 50 determining the piston position and therefore being able to also detect changes in the piston stroke s. The measuring mechanism 50 is connected to the control mechanism 40 and the control mechanism 40 is connected to the proportional valve mechanism 60 for data exchange and/or signal exchange via the data lines 41. By means of the control mechanism 40, the measured values of the measuring mechanism 50 can be evaluated with regard to the piston position and/or the piston stroke, a comparison between a target value and an actual value being carried out by the control mechanism 40, for example. The proportional valve mechanism 60 can be electrically controlled by the control mechanism 40 so that, if necessary, the volume flow of compressed fluid H supplied to the cylinder casing 33 of the actuation mechanism 30 can be changed in order to change the opening and closing behavior of the check valve mechanism 20.

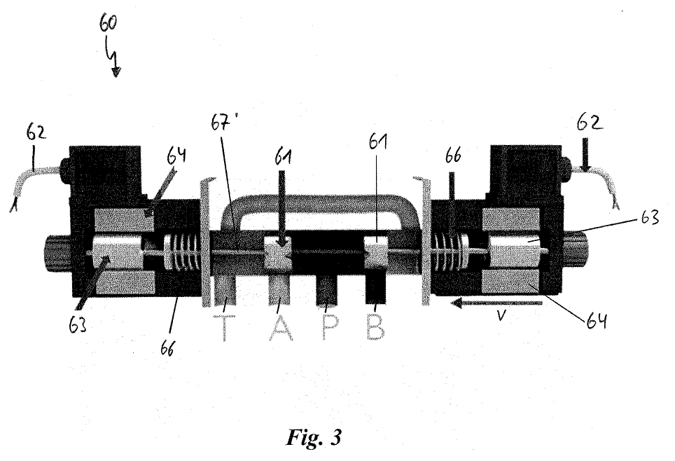

FIG. 3 shows the proportional valve mechanism 60 in its sole position. The proportional valve mechanism 60 is designed as a 4/4 proportional valve and therefore has four valve connections A, B, P, T for supplying and/or discharging the compressed fluid H. The valve connections are labeled T for tank, P for pressure and A and B for consumer. In particular, the volume flows of compressed fluid H, which are supplied from the proportional valve mechanism 60 to the actuation mechanism 30, especially to the cylinder casing 33, can be precisely controlled via different positions of the valve piston 61 due to the continuous switching behavior of the proportional valve mechanism 60. This switching behavior is made possible by the magnets 63 and coils 64, which are electrically controllable and can therefore move the valve piston 61 to different valve piston positions. As can be seen in FIG. 3, the magnets 63 are disposed together with the valve piston 61 on a shared axis 67. The magnets 63 are disposed at both ends of the axis 67 and are each subjected to a horizontal force via the controllable coil 64 as shown in the embodiment, resulting in the axis 67 being able to be moved in the direction of axial movement V with the valve piston 61 disposed in a fixed position on the axis 67. Thus, due to the supply of current to the coil 64, which interacts with the magnets 63, a movement of the axis 67 is effected, since the magnet 63 and the valve piston 61 are disposed stationary on the axis 67. If no current is applied to the coil 64, the magnet 63 can be returned to a home position via one of the valve springs 66, the valve connections A and B leading to the consumer (not shown here) being closed in the home position. The home position is shown in FIG. 3. In the end positions, i.e., the maximum deflection of the valve pistons 61, different valve connections A, B, P, T are connected to each other. As shown in the right end position, the valve connection T is connected to the valve connection A and the valve connection P is connected to the valve connection B. In the left end position, the valve connection T is connected to the valve connection B and the valve connection P is connected to the valve connection A. The electric current causing the axis 67 to move can be supplied via the electrical connection 62. The control mechanism 40 (not shown here) is designed to control the current supplied to the proportional valve mechanism 60 and thereby control the opening behavior of the check valve mechanism 20. The supply of compressed fluid H to the hydraulic cylinder 31 (not shown in FIG. 3) of the actuation mechanism 30 which interacts with the check valve device 20 to actuate it, enables a modulating opening behavior of the check valve device 20, which ensures a more efficient use of the compressed air.

1. A valve device (10) having a check valve mechanism (20) having a valve rod (21) and a closing element (22) disposed on one end of the valve rod (21) and intended for the compressed-air supply to a consumer (11),
the valve device (10) further having an actuation mechanism (30) having a hydraulic cylinder (31), the piston (32) of the hydraulic cylinder (31) being firmly connected to the valve rod (21) and being hydraulically driven within the cylinder casing (33) of the hydraulic cylinder (31) in order to actuate the check valve mechanism (20),
wherein
a control mechanism (40) for controlling the piston movement and
a measuring mechanism (50) for detecting the piston position is comprised, a proportional-valve mechanism (60), which is controllable by the control mechanism (40) as a function of the piston position, being connected to the hydraulic cylinder (31) in a fluid-conducting manner.

2. The valve device according to claim 1,
wherein
the measuring mechanism (50) has a laser triangulation sensor or a touchless path sensor or an ultrasonic distance sensor in order to detect the piston position.

3. The valve device according to claim 1,
wherein
the proportional-valve mechanism (60) is designed as a 4/4 proportional valve.

4. The valve device according to claim 1,
wherein
the valve piston (61) of the proportional-valve mechanism (60) is displaceable by being current-controlled.

5. The valve device according to claim 1,
wherein
the control mechanism (40) has a PID controller.

6. The valve device according to claim 1,
wherein
the piston (32) is double-acting.

7. The valve device according to claim 1,
wherein
a piston rod (34) is disposed on the piston (32), opposite the valve rod (21) and disposed so as to align flush with the axis thereof, the valve rod (21) and the piston rod (34) having differing diameters.

8. The valve device according to claim 1,
wherein the movement(s) of the piston (32) is limited by an immovable stop element (35).

9. The valve device according to claim 1,
wherein a piston rod (34) is disposed on the piston (32), opposite the valve rod (21) and disposed so as to align flush with the axis thereof, the free front face (34a) of the piston rod (34) facing away from the closing element (21) being abutted against the stop element (35).

10. The valve device according to claim 9,
wherein
a stop damper (35b) is provided on the free front face (34a) of the piston rod (32) or on the stop element (35).

11. The valve device according to claim 1,
wherein
an immovable return spring (36) is disposed in such a manner that the valve rod (21) is moved against the spring force of the return spring (36) when opening the check valve mechanism (20).

12. The valve device according to claim 1,
wherein
an adjustable pressure control mechanism (12) is disposed upstream of the proportional valve element (60).

13. A molding machine (70) for compressing a molding material (71) having a molding box (72) fillable with the molding material (71), a model (73) being disposed in the molding box (72), and the molding box (72) being connected to a compressed-air supply (D), and the molding machine (70) further comprising a valve device (10) according to claim 1 for releasing the compressed-air supply (D) to the molding box (72), a mold being formed by being subjected to pressure and subsequently compressing the molding material (71).

14. A method for controlling a valve device (10) having a check valve mechanism (20) having a valve rod (21) and a closing element (22) disposed on one end on the valve rod (21) and intended for the compressed-air supply (D) to a consumer (11), the valve device (10) further having an actuation mechanism (30) having a hydraulic cylinder (31), the piston (32) of the hydraulic cylinder (31) being firmly connected to the valve rod (21) and being hydraulically driven within the cylinder casing (33) of the hydraulic cylinder (31) in order to actuate the check valve mechanism (20),
the piston position being determined by means of a measuring mechanism (50), and the piston movement being controlled as a function of the determined piston position by a proportional-valve mechanism (60) connected to the hydraulic cylinder in a fluid-conducting manner being controlled in such a manner that the volume flow of hydraulic fluid (H) supplied to the hydraulic cylinder (31) is changed.

15. The method according to claim 14,
wherein the piston position or the piston stroke is determined in regular temporal intervals by means of the measuring mechanism (50) and is transmitted as an actual value to a control device (40), the actual value being compared to a target value by means of the control mechanism (40), and the control signal emitted for controlling the proportional-valve mechanism (60) being changed by the control mechanism (40) when a target value and an actual value deviate.
